(19) United States
(12) Patent Application Publication
(10) Pub. No.: US 2025/0363323 A1
(43) Pub. Date: Nov. 27, 2025

(54) TRANSACTION CARD HAVING A BIOMETRIC SENSOR AND LIMITED CARD DATA INDICIA

(71) Applicant: CJG Tech LLC, Dallas, TX (US)

(72) Inventor: Darryl GEIGER, DeSoto, TX (US)

(21) Appl. No.: 19/274,233

(22) Filed: Jul. 18, 2025

Related U.S. Application Data
(63) Continuation-in-part of application No. 18/241,322, filed on Sep. 1, 2023, now Pat. No. 12,400,217.
(60) Provisional application No. 63/405,794, filed on Sep. 12, 2022.

(51) Int. Cl. G06K 19/07; G06Q 20/40

(52) U.S. Cl. CPC G06K 19/0718; G06Q 20/40145; G06Q 20/407

(57) ABSTRACT

A transaction card for secure payments is provided. The transaction card includes a personalized indicia on a surface. It can also include an encoded portion to communicate with a card reader, where a complete transaction card number is stored. Additionally, the card may have a biometric sensor, which can communicate with the card reader to complete a transaction. A method for conducting a transaction using such a card is also provided. The method involves receiving a communication from the encoded portion at the card reader, where the communication includes the complete transaction card number with the personalized indicia. Next, a biometric input from the card's sensor can be received by the card reader. The complete transaction card number and biometric input are then transmitted to the issuer for authorization. An authorization response is received from the issuer, and finally, an authorization notification is generated at the card reader.

### CROSS-REFERENCE TO RELATED APPLICATIONS

This application is a continuation-in-part of co-pending U.S. Non-Provisional application Ser. No. 18/241,322, filed Sep. 1, 2023, which claims priority to U.S. Provisional Application No. 63/405,794, filed on Sep. 12, 2022, the contents of which are hereby incorporated by reference in their entirety.

### BACKGROUND

### Technical Field

The present disclosure relates to credit card security. More particularly, and not by way of limitation, the present disclosure is directed to an apparatus, system, and/or method for a credit card having limited card data.

### Description of Related Art

Traditional credit cards provide various ways of communicating transaction data. A first type of credit card utilizes a magnetic strip for swiping through credit card readers, automated teller machines (ATMs), and other devices that support the present credit card and banking infrastructure. Another type of credit card utilizes a chip having a microprocessor to communicate with credit card readers. Another type of credit card utilizes radio frequencies to wirelessly communicate with credit card readers. However, each of the available credit card types remains susceptible to fraud and/or misappropriation because they display complete information associated with the credit card holder and/or account. It would be advantageous to have an apparatus, system, and/or method for a credit card having limited card data that overcomes the disadvantages of the art. The present disclosure provides such an apparatus, system, and method.

### BRIEF SUMMARY

This summary provides a discussion of aspects of certain embodiments of the invention. It is not intended to limit the claimed invention or any of the terms in the claims. The summary provides some aspects, but there are aspects and embodiments of the invention that are not discussed here.

In one aspect, a transaction card for secure payments is provided. The transaction card may include a personalized indicia displayed on either a first surface or a second surface of the transaction card. The transaction card can also include an encoded portion configured to communicate with a transaction card reader, where a complete transaction card number associated with the transaction card is stored on the encoded portion. Additionally, the transaction card can include a biometric sensor positioned on either surface, which can be configured to communicate with the card reader to complete a transaction.

In one embodiment, the complete transaction card number can include the personalized indicia. Additionally, or alternatively, the personalized indicia can include numbers, letters, or any combination thereof. When the complete transaction card number is transmitted to the transaction card reader for authorizing a payment, only the personalized indicia is displayed on the transaction card reader.

In another embodiment, a billing address associated with the transaction card is stored on the encoded portion.

In another embodiment, the encoded portion can be a magnetic strip, a contact chip, a contactless chip, or any combination thereof. Additionally, or alternatively, the biometric sensor can include a fingerprint sensor, a facial recognition sensor, or any combination thereof.

In yet another embodiment, the personalized indicia can be displayed on the first surface of the secure transaction card, and further wherein the fingerprint sensor is disposed on the first surface of the secure transaction card. Alternatively, the personalized indicia can be displayed on the first surface of the secure transaction card, and further wherein the fingerprint sensor is disposed on the second surface of the secure transaction card.

In another aspect, a method for conducting a transaction at a transaction card reader is provided. The method can include receiving a communication from an encoded portion of a transaction card at the transaction card reader, where the communication includes a complete transaction card number stored on the encoded portion, and where the complete transaction card number includes a personalized indicia. Next, a biometric input collected by a biometric sensor on the transaction card can be received at the transaction card reader. The complete transaction card number and biometric input can then be transmitted to an issuer of the transaction card for authorization of the transaction. An authorization response from the issuer can be received at the transaction card reader. Finally, an authorization notification can be generated at the transaction card reader.

In one embodiment, receiving the communication and receiving the biometric input can occur simultaneously.

In another embodiment, generating the authorization notification can include displaying only the personalized indicia portion of the complete transaction number.

In another embodiment, the biometric input can include a fingerprint scan, a facial recognition scan, or any combination thereof.

In yet another embodiment, the authorization response and the authorization notification can be indicative of an approval of the transaction, thereby completing the transaction.

In still another embodiment, the authorization response and the authorization notification can be indicative of a denial of the transaction, thereby voiding the transaction.

In another aspect, an alternative method for conducting a transaction at a transaction card reader is provided. A communication from an encoded portion of a transaction card can be received by the transaction card reader, where the communication includes a complete transaction card number stored on the encoded portion, and wherein the complete transaction card number includes a personalized indicia. The complete transaction card number can then be transmitted to the issuer of the transaction card for initial authorization of the transaction. An initial authorization response from the issuer can be received at the transaction card reader. A notification of initial authorization can then be generated at the transaction card reader. Additionally, biometric input collected by a biometric sensor on the transaction card can be received at the transaction card reader. This biometric input can then be sent to the issuer for final authorization. A final authorization response from the issuer can be received at the transaction card reader, and a final authorization notification can then be generated at the transaction card reader.

In one embodiment, generating the initial and final authorization notifications can each include displaying only the personalized indicia portion of the complete transaction number.

In another embodiment, the biometric input can include a fingerprint scan, a facial recognition scan, or any combination thereof.

In yet another embodiment, the final authorization response and the final authorization notification can be indicative of an approval of the transaction, thereby completing the transaction.

In still another embodiment, the final authorization response and the final authorization notification can be indicative of a denial of the transaction, thereby voiding the transaction.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1A is a front view of a transaction card.

FIG. 1B is a rear view of the transaction card in FIG. 1A.

FIG. 2 is a diagram of an overview of an embodiment of an implementation described herein.

FIG. 3 is a diagram of an environment in which systems and/or methods, described herein, may be implemented.

FIG. 4 is a diagram of example components of one or more devices of FIG. 3.

FIG. 5A is a front view of an alternative embodiment of a transaction card.

FIG. 5B is a rear view of the transaction card in FIG. 5A.

FIG. 6 is a diagram of an overview of an alternative embodiment of an implementation described herein.

### DETAILED DESCRIPTION

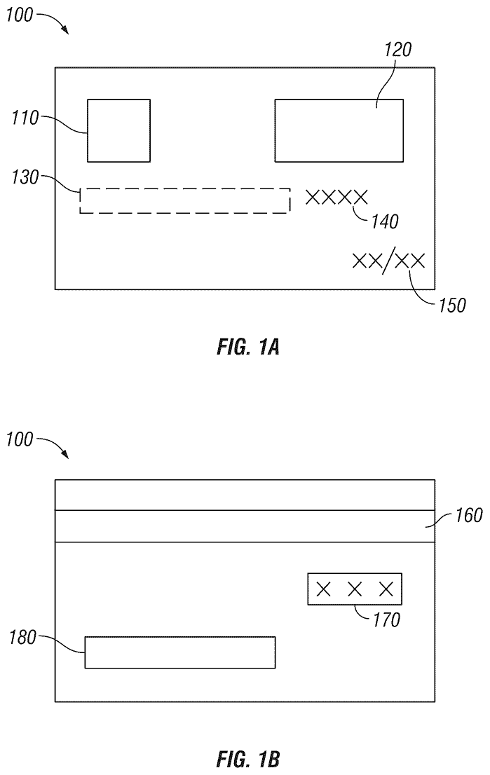

FIGS. 1A-1B illustrates front and rear views of a transaction card 100 for secure payments. The transaction card 100 may be a credit card, debit card, gift card, or any similar financial instrument known in the art. The transaction card 100 may include an encoded portion 110, 160 an issuer identification 120, a personalized indicia 140, and an expiration date 150. The encoded portion 110, 160 may be a magnetic strip, a contact chip, and/or a contactless chip. The encoded portion 110, 160 is configured to communicate with a transaction card reader for payment of goods and/or services. The issuer identification 120 is a marking identifying the name of the financial institution or company issuing the transaction card 100 to a user. The expiration date 150 indicates the date through which the transaction card 100 is valid.

The personalized indicia 140 is displayed on the transaction card 100 and comprises characters such as numbers, letters, symbols, or any combination thereof. The user of the transaction card 100 selects the personalized indicia 140. While the length of the characters in the personalized indicia 140 may vary between one and ten characters. In at least one example, the personalized indicia 140 comprises four characters. The personalized indicia 140 may form a portion of the transaction card number, but only the personalized indicia 140 is displayed on the transaction card 100. The remaining portion 130 of the transaction card number is not displayed to enhance the security of the transaction card 100. The complete transaction card number is stored on the encoded portion 110 for communication with the transaction card reader. In at least one example, the transaction card number comprises sixteen digits, with four sets of four digits. The user may select any set of four digits for display as the personalized indicia 140. In another example, the user can choose any four digits within the sixteen-digit transaction card number for display as the personalized indicia 140. The encoded portion 110 may also include information relating to the user's name, the issuing bank, expiration date, credit card verification numbers, and type of credit card. The transaction card 100 may also include a card verification value 170 and a user signature block 180 for added security.

It is advantageous to display only the personalized indicia 140 on the transaction card 100 because it decreases the likelihood of fraudulent transactions. Traditional cards display the complete account number and other information on one of the faces of the card, which enables others to misappropriate the card by memorizing or copying the card information. For example, cards are generally presented to servers at restaurants and bars to open a “tab” for the food and drinks that the patron orders. If the server retains the card until the patron closes the tab, the card is susceptible to copying without the patron's knowledge. By displaying only the personalized indicia 140 on the transaction card, another person cannot capture the necessary card information for purchases that do not require presenting the card for payment.

Moreover, the personalized indicia 140 still enables merchants to verify a purchase before approval. For example, a server can compare the receipt corresponding to the user's closed tab and verify that the ending characters match with the characters of the personalized indicia 140. Other information from the encoded portion 110, 160 can be compared to the visible information appearing on the face of the card portion to verify the card and purchase. It is also advantageous for the user to select the personalized indicia 140 because the user is more likely to remember the personalized indicia 140 compared to random indicia or the full transaction card number. It is also advantageous in situations where the user has multiple transaction cards because the user is not required to memorize or remember multiple, random indicia.

Another security benefit of the transaction card 100 is the ability for a customer to obtain the remaining portion 130 of the transaction card number. For example, if the customer forgets the remaining portion 130 of the transaction card number, they may request the information by notifying the bank or card issuer. The bank or card issuer will send the information to the customer via a preferred secure notification method, which the customer selects when signing up for the transaction card 100. The secure notification method may include text message, email, app notification, phone call, or other secure notification methods.

The process for creating or manufacturing the transaction card 100 involves the user selecting a personalized indicia that will be associated with the transaction card 100. The personalized indicia 140 selected by the user may form a portion of the number associated with the transaction card 100. For example, the account number for a transaction card 100 may contain about sixteen characters, with the last three or four characters identifying the user's account number. In configurations where the personalized indicia 140 forms a portion of the transaction card number, the user is selecting the last three or four characters of the transaction card number. Alternatively, the personalized indicia 140 may form an added portion of the transaction card number where the user is selecting three or four characters to add to the transaction card number. Once selected, the personalized indicia 140 is displayed on the transaction card 100. In one example, the personalized indicia 140 is displayed at a bottom portion of the top surface of the transaction card 100. In another example, the personalized indicia 140 is displayed at a bottom portion of the bottom surface of the transaction card 100. The personalized indicia 140 may also be displayed at any other portion of any surface of the transaction card 100. The complete transaction card number is stored on the encoded portion 110, 160 of the transaction card 100. The personalized indicia 140 of the transaction card 100 may comprise characters such as numbers, letters, symbols, or any combination thereof.

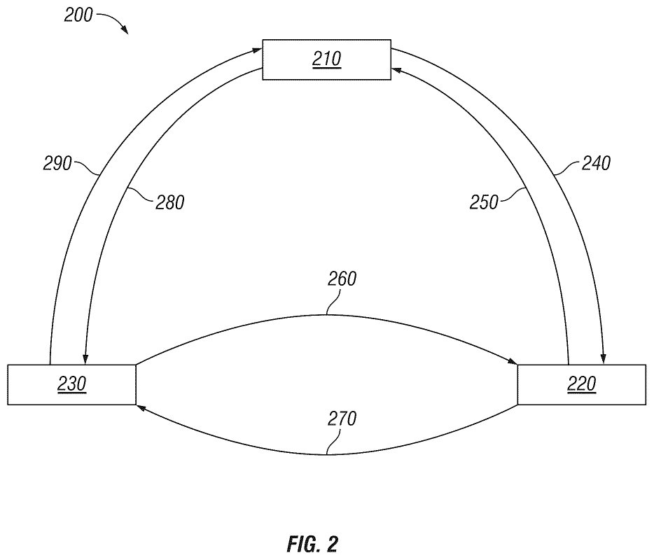

FIG. 2 is a diagram illustrating a simplified transaction process 200 involving the disclosed transaction card. The transaction process 200 involves the user 210 purchasing goods or services from a merchant 220. The transaction card is swiped, tapped, or inserted into a transaction card reader for sending a credit payment 240 to the merchant 220. The merchant 220 submits a reimbursement request and the transaction card information 270 to the issuing bank 230. The issuing bank 230 may include the transaction card issuer. The issuing bank 230 reviews the transaction card information 270 and the available funds in the account associated with the transaction card. The issuing bank 230 validates the transaction card if the transaction card information 270 is verified and the account has sufficient funds for the purchase. Upon receiving a notification that the transaction card information 270 is verified, the merchant 220 provides the purchased goods or services 250. The issuing bank 230 transmits the requested reimbursement 260 to the merchant when the transaction card is validated. The issuing bank 230 submits an invoice 290 to the user 210 for the accrued charges to the user's account, to which the user 210 submits a payment 280.

During the transaction process 200, the complete transaction card number (e.g., account number) is never publicly displayed. Importantly, the complete transaction card number is not provided during the credit payment 240 or the receipt of the goods or services 250. Instead, transactions 240 and 250 only disclose the personalized indicia of the transaction card. Further, the merchant may verify the credit card by comparing the personalized indicia with the visible account characters on the receipt.

In another embodiment, a user 210 may set a charge limit on the amount that can be charged in a single credit card payment 240. If the credit card payment 240 exceeds the charge limit, then a charge limit alert will be sent to the user 210. In at least one example, the alert may be sent to the user 210 via text message, email, app notification, phone call, or other secure notification method. In some embodiments, the alert contains information describing the transaction 250, the credit payment 240, the merchant 202, the time, date, location of the transaction 250, or other relevant information.

The charge limit alert may ask the user 210 whether the transaction 250 is authorized or not. If the user 210 confirms the transaction 250, then the transaction process 200 proceeds normally. If the user 210 annuls the transaction 250, then the bank 230 will decline the merchant's 220 reimbursement request 270. Declining the merchant's 220 reimbursement request 270 stops the transaction 250 and will prevent the user's 210 account from being charged the credit card payment 240 amount. This technique provides the benefit of stopping fraudulent transactions with the transaction card because the user 210 becomes notified about the transaction 250 from the charge limit alert and must confirm the transaction 250 before the bank 230 sends a reimbursement 260 to the merchant 220.

In another embodiment, the transaction process 200 does not involve the transaction card, but instead involves the user 210 purchasing goods or services from a merchant 220 online. Instead of swiping, tapping, or inserting the transaction card, the user 210 enters the transaction card number with the merchant's 220 online payment portal to make a purchase. The merchant 220 submits a reimbursement request and the transaction card information 270 to the issuing bank 230. The user 210 will be sent an online purchase alert regarding the transaction 250. In at least one example, the alert may be sent to the user 210 via text message, email, app notification, phone call, or other secure notification method. In some embodiments, the alert contains information describing the transaction 250, the credit payment 240, the merchant 202, the time, date, and location of the transaction 250, or other relevant information. If the user 210 confirms the transaction 250, then the transaction process 200 proceeds normally. If the user 210 annuls the transaction 250, then the bank 230 will decline the merchant's 220 reimbursement request 270. Declining the merchant's 220 reimbursement request 270 stops the transaction 250 and will prevent the user's 210 account from being charged the credit payment 240 amount.

In yet further embodiments, the user 210 may purchase a monthly subscription from a merchant 220 using the transaction card or the transaction card number online. The merchant 220 submits a reimbursement request and the transaction card information 270 to the issuing bank 230. The user 210 will be sent a subscription alert regarding the recurring transaction 250. In at least one example, the alert may be sent to the user 210 via text message, email, app notification, phone call, or other secure notification method. In some embodiments, the alert contains information describing the transaction 250, the credit payment 240, the merchant 202, the time, date, and location of the transaction 250, or other relevant information. In at least one example, the user 210 will need to provide details about the merchant 220 to confirm the recurring transaction 250. The user 210 may need to provide the merchant's 220 name, address, phone number, or other information. After the bank 230 receives and verifies the information, the credit payment 240 will be charged every subscription period. The subscription period may be monthly, yearly, or some other fixed period. If the user 210 has set a charge limit on the transaction card, then the subscription credit payment 240 must be less than the charge payment to automatically process at every subscription period. Otherwise, the user 210 will be sent a charge limit alert as described above. If the user 210 annuls the transaction 250, then the bank 230 will decline the merchant's 220 reimbursement request 270.

In yet another embodiment, the user 210 may confirm the transaction 250 with the merchant 220 by selecting an option within each alert titled “yes,” or some equivalent thereof. The user 210 may annul the transaction 250 with the merchant 220 by selecting an option within each alert titled “no,” or some equivalent thereof. In one example, an alert will be sent to the user 210 for every subsequent transaction with the merchant 220.

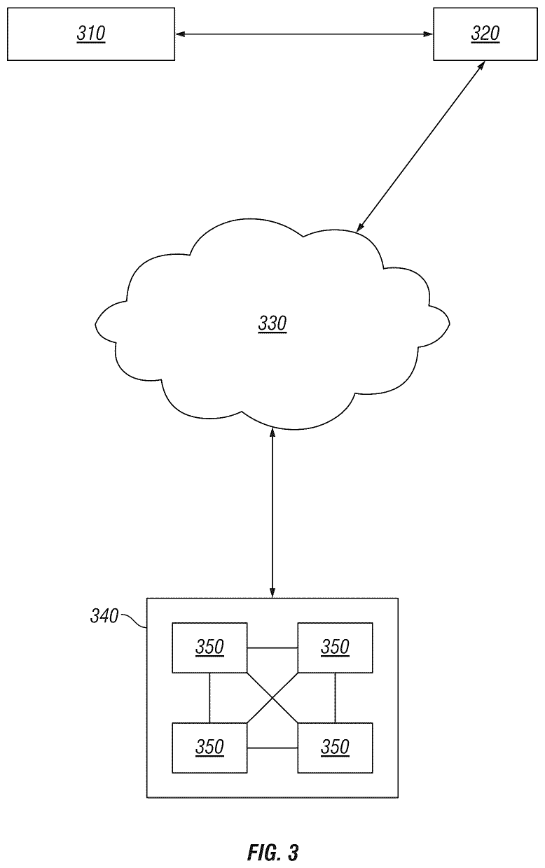

FIG. 3 is a diagram illustrating a simplified environment implementing systems and/or methods, described herein. The environment includes a transaction card 310, a transaction card reader 320, and an issuing bank platform 340. As described herein, the transaction card 310 may include an encoded portion and a personalized indicia. The encoded portion stores the complete transaction card number and is configured to communicate with the transaction card reader 320. The transaction card reader 320 and the issuing bank platform 340 may communicate via a network 330.

The issuing bank platform 340 may include one or more devices 350 capable of receiving, generating, storing, processing, and/or providing information associated with the transaction card. For example, the issuing bank platform 340 may include a server, a group of servers, and/or the like. In some configurations, the issuing bank platform 340 may be partially or entirely implemented in a cloud computing environment. A cloud computing environment includes an environment that delivers computing as a service, whereby shared resources, services, etc. may be provided to the issuing bank platform 340.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment may perform one or more functions described as being performed by another set of devices or the environment.

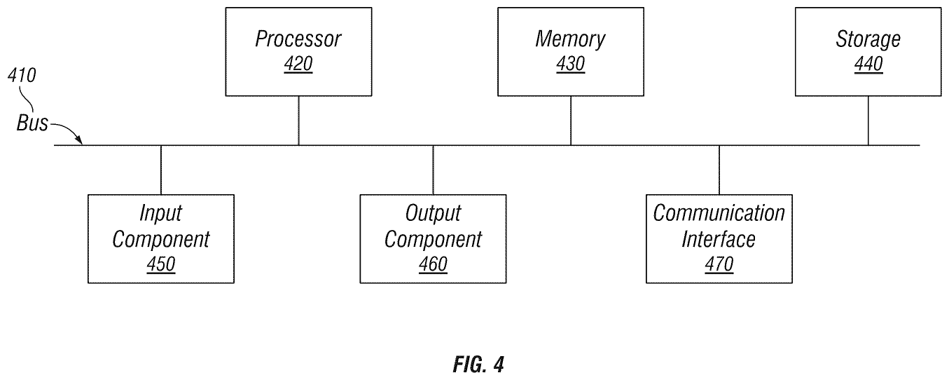

FIG. 4 is an illustration of example components of a device (not pictured). The device may correspond to the transaction card reader and/or the issuing bank platform. In some configurations, the transaction card reader and the issuing bank platform may include one or more devices and/or one or more components of the device. As shown in FIG. 4, the device may include a bus 410, a processor 420, a memory 430, a storage component 440, an input component 450, an output component 460, and a communication interface 470.

Bus 410 includes a component that permits communication among the components of the device. Processor 420 is implemented in hardware, firmware, or a combination of hardware and software. The processor 420 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 420 includes one or more processors capable of being programmed to perform a function. Memory 430 includes a random access memory (RAM), a read only memory (ROM), and/or another type of dynamic or static storage device (e.g., a flash memory, a magnetic memory, and/or an optical memory) that stores information and/or instructions for use by processor 420.

Storage component 440 stores information and/or software related to the operation and use of the device. For example, storage component 440 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 450 includes a component that permits the device to receive information, such as via user input (e.g., a touch screen display, a keyboard, a keypad, a mouse, a button, a switch, and/or a microphone). Additionally, or alternatively, input component 450 may include a sensor for sensing information (e.g., a global positioning system (GPS) component, an accelerometer, a gyroscope, and/or an actuator). Output component 460 includes a component that provides output information from the device (e.g., a display, a speaker, and/or one or more light-emitting diodes (LEDs)).

Communication interface 470 includes a transceiver-like component (e.g., a transceiver and/or a separate receiver and transmitter) that enables the device to communicate with other devices, such as via a wired connection, a wireless connection, or a combination of wired and wireless connections. Communication interface 470 may permit the device to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, or the like.

The device may perform one or more processes described herein. The device may perform these processes based on the processor 420 executing software instructions stored by a non-transitory computer-readable medium, such as memory 430 and/or storage component 440. A computer-readable medium is defined herein as a non-transitory memory device. A memory device includes memory space within a single physical storage device or memory space spread across multiple physical storage devices.

Software instructions may be read into memory 430 and/or storage component 440 from another computer-readable medium or from another device via communication interface 470. When executed, software instructions stored in memory 430 and/or storage component 440 may cause processor 420 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device may include additional components, fewer components, different components, or differently arranged components than those shown in FIG. 4. Additionally, or alternatively, a set of components (e.g., one or more components) of the device may perform one or more functions described as being performed by another set of components of the device.

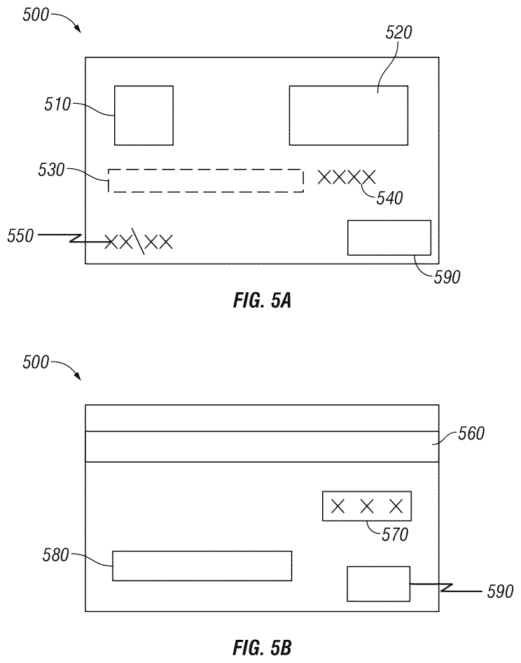

Turning to FIGS. 5A and 5B, front and rear views of an alternative embodiment of a transaction card 500 are shown. Consistent with the embodiments of the previously described transaction cards, the transaction card 500 in this illustrative embodiment can be a credit card, debit card, gift card, or any similar financial instrument known in the art. The transaction card 500 may include an encoded portion 510, 560, an issuer identification 520, a personalized indicia 540, and an expiration date 550. The encoded portions 510, 560 may be a magnetic strip, a contact chip, and/or a contactless chip. These encoded portions are configured to communicate with a transaction card reader for payment of goods and/or services. Although the embodiment depicted shows multiple encoded portions 510, 560, it is understood that the transaction card 500 may have one or both encoded portions. The issuer identification 520 is a marking that identifies the name of the financial institution or company issuing the transaction card 500 to a user. The expiration date 550 indicates the date through which the transaction card 500 remains valid. Additionally, the transaction card 500 can have a biometric sensor 590 on the front side (FIG. 5A), the back side (FIG. 5B), or both sides. As explained in further detail, the combination of the personalized indicia 540 and the biometric scanner 590 greatly enhances the security of the transaction card (and the associated account), reducing the potential for fraudulent access. The biometric sensor 590 can be a fingerprint sensor (or scanner), a facial recognition sensor (or scanner), a retinal sensor (or scanner), or any combination of these.

The personalized indicia 540 appears on the transaction card 500 and includes characters such as numbers, letters, symbols, or any combination of these. The user of the transaction card 500 chooses the personalized indicia 540. While the length of the characters in the personalized indicia 540 can vary between one and ten characters, in at least one example, it consists of four characters. The personalized indicia 540 can be part of the transaction card number, but only the personalized indicia 540 is visible on the transaction card 500. The rest of the transaction card number, referred to as portion 530, is not displayed to improve security. The full transaction card number is stored on the encoded portion 510 for communication with the card reader. In at least one example, the transaction card number has sixteen digits divided into four groups of four digits each. The user can select any four-digit set to display as the personalized indicia 540. Alternatively, the user may choose any four digits from the sixteen-digit transaction card number for display as the personalized indicia 540. The encoded portion 510 may also contain information such as the user's name, issuing bank, expiration date, credit card verification numbers, and card type. Additionally, the transaction card 500 might include a card verification value 570 and a user signature block 580 for extra security.

Consistent with the previously described embodiments, displaying only the personalized indicia 540 on the transaction card 500 is advantageous because it reduces the risk of fraudulent transactions. Traditional cards are highly vulnerable to fraud because they display the full account number and other details, allowing others to misappropriate the card by memorizing or copying this information. For example, cards are often shown to servers at restaurants and bars to open a “tab” for food and drinks ordered. If the server keeps the card until the patron closes the tab, the card is at risk of being copied without the patron knowing. By only displaying the personalized indicia 540 on the transaction card, another person cannot capture the necessary card information for purchases that do not involve presenting the card for payment.

The transaction card 500 still offers the benefits of traditional cards. For example, it allows merchants to verify a purchase before approval by enabling a server to compare the receipt from the user's closed tab and check if the ending characters match the personalized indicia 540. Additional information from encoded sections 510, 560 can also be compared to the visible details on the face of the card to verify both the card and the purchase. It is also advantageous for users to select the personalized indicia 540 because they are more likely to remember it compared to random indicia or the full transaction card number. This is especially useful when the user has multiple transaction cards, as it eliminates the need to memorize or recall multiple, random indicia.

Users can still obtain the remaining portion 530 of the transaction card number. For example, if the customer forgets this part, they can request it by notifying the bank or card issuer. The bank or card issuer will send the information to the customer through a preferred secure notification method, which the customer chooses when signing up for the transaction card 500. This secure notification method may include text message, email, app notification, phone call, or other secure methods.

Furthermore, the added security of the biometric sensor further reduces the risk of fraudulent activity. Continuing with the restaurant (or bar) example, the server (or merchant) will only be able to close the tab when the patron provides a biometric input to the biometric sensor 590, which is transmitted to the card reader. As described further below, the card reader transmits this biometric input to the card issuer, who will verify its validity. Once a response confirms the biometric input is valid, the tab can be closed. In some embodiments, the biometric input can be limited solely to the primary user of the transaction card 500. In other cases, the biometric input can include the primary user and any other users authorized on the account. For example, when the primary user authorizes others to use the account (e.g., spouse, children, siblings, business partners, etc.), those users will submit their biometric input to be linked with the transaction card 500 and the associated account.

Therefore, in accordance with the disclosed embodiments, the user (and any authorized users) will submit or store their fingerprint scan, face scan, or retinal scan.

The process for creating or manufacturing the transaction card 500 is similar to the one described for previous embodiments, but involves additional steps for the biometric input. In one embodiment, the user provides a biometric input to the biometric sensor 590, which is then linked to the associated account. The user can provide this biometric input either before, after, or at the same time as submitting the personalized indicia. Submitting the biometric input can include the user placing the transaction card 500 in contact with a card reader connected to the user's account. Once the communication link between the transaction card 500 and the account is established, the user submits the biometric input, which is then saved to the account. In an alternative embodiment, the user can submit their biometric input without using the biometric sensor 590 on the transaction card 500. For example, the user may submit their biometric input to a separate biometric sensor linked to their account. Authorized users can follow the same steps to associate their biometric inputs with the account.

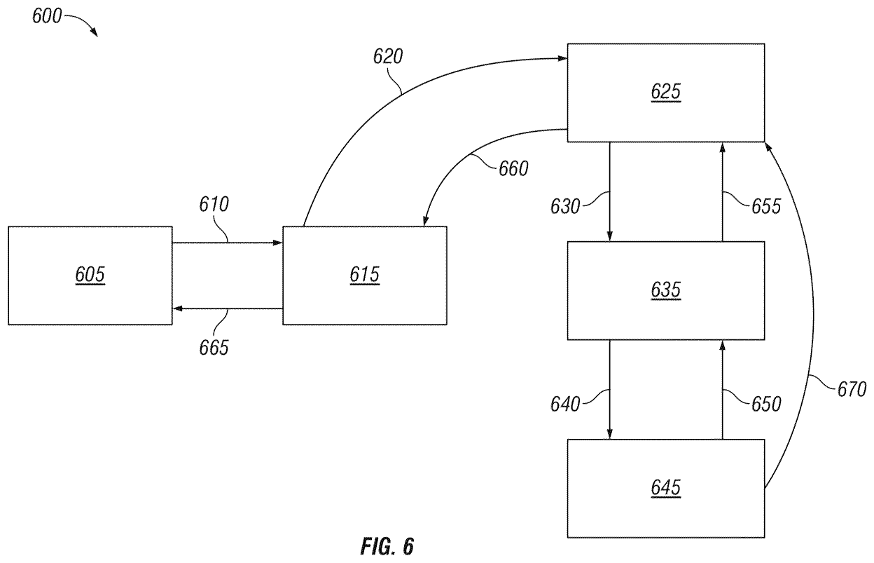

Referring to FIG. 6, another simplified transaction process 600 is illustrated. The transaction process 600 shown in FIG. 6 is similar to the process 200 in FIG. 2. However, the transaction process 600 also includes additional biometric input functionality. It begins with the user placing the transaction card 605 in communication 610 with a card reader 615 to start the transaction. Among the typical card information, the communication 610 involves transmitting the complete transaction card number stored on the encoded portion of the transaction card 605 to the card reader 615. The complete transaction card number includes the personalized indicia selected by the user. The card reader 615 transmits this information 620 to the merchant's bank (or an acquirer) 625 to request authorization for the transaction. The merchant's bank 625 forwards the information 630 to a card network 635 (e.g., Visa, MasterCard, Amex, etc.) to seek approval. The card network 635 identifies the issuing bank 645 and sends a request 640 for authorization, including transmitting the information 610 transmitted from the transaction card 605 to the card reader 615.

The issuing bank 645 evaluates the transaction card's validity, available funds, potential fraud, and/or any cardholder restrictions. The issuing bank's 645 assessment also includes verifying if the biometric input matches the one linked to the account. The issuing bank 645 then sends an authorization response (i.e., approved or declined) 650 to the card network 635, which forwards the response 655 to the merchant's bank 625. That bank 625 subsequently sends the authorization response 660 to the card reader 615. Upon receiving this response 660, the card reader 615 generates an authorization notification (e.g., a receipt or denial) 665. If approved, the issuing bank 645 routes the payment 670 for the transaction to the merchant's bank 625, which deposits the funds into the merchant's account. This payment 670 can be transferred directly to the merchant's bank 625 or through the card network 635. In accordance with the principles outlined in previous embodiments, the complete transaction number will never be displayed or publicly accessible during the transaction process 600. Instead, only the personalized indicia will be visible or accessible to the public.

With reference to FIG. 3, the disclosed transaction card (500, 605) described in FIGS. 5A, 5B, and 6 is implemented in a similar manner to transaction card 310 in the depicted environment. Similarly, the components illustrated and described in connection with FIG. 4 apply to the components shown and described in FIG. 6.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in the described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A transaction card for secure payments comprising:
a personalized indicia displayed on a first surface or a second surface of the transaction card;
an encoded portion configured to communicate with a transaction card reader, wherein a complete transaction card number associated with the transaction card is stored on the encoded portion; and
a biometric sensor disposed on the first surface or the second surface, wherein the biometric sensor is configured to communicate with the transaction card reader to complete a transaction.

2. The transaction card of claim 1, wherein the personalized indicia comprises numbers, letters, or any combination thereof.

3. The transaction card of claim 1, wherein the complete transaction card number includes the personalized indicia.

4. The transaction card of claim 3, wherein when the complete transaction card number is transmitted to the transaction card reader for authorizing a payment, only the personalized indicia is displayed on the transaction card reader.

5. The transaction card of claim 1, wherein a billing address associated with the transaction card is stored on the encoded portion.

6. The transaction card of claim 1, wherein the encoded portion is a magnetic strip, a contact chip, a contactless chip, or any combination thereof.

7. The transaction card of claim 1, wherein the personalized indicia is displayed on the first surface of the secure transaction card, and further wherein the fingerprint sensor is disposed on the first surface of the secure transaction card.

8. The transaction card of claim 1, wherein the personalized indicia is displayed on the first surface of the secure transaction card, and further wherein the fingerprint sensor is disposed on the second surface of the secure transaction card.

9. The transaction card of claim 1, wherein the biometric sensor comprises a fingerprint sensor, a facial recognition sensor, or any combination thereof.

10. A method for conducting a transaction at a transaction card reader, the method comprising:
receiving a communication from an encoded portion of a transaction card at the transaction card reader, wherein the communication comprises a complete transaction card number stored on the encoded portion, and wherein the complete transaction card number includes a personalized indicia;
receiving a biometric input collected by a biometric sensor on the transaction card at the transaction card reader;
transmitting the complete transaction card number and the biometric input to an issuer of the transaction card for authorization of the transaction;
receiving an authorization response from the issuer of the transaction card at the transaction card reader; and
generating an authorization notification at the transaction card reader.

11. The method of claim 10, wherein receiving the communication and receiving the biometric input occur simultaneously.

12. The method of claim 10, wherein generating the authorization notification comprises displaying only the personalized indicia portion of the complete transaction number.

13. The method of claim 10, wherein the biometric input comprises a fingerprint scan, a facial recognition scan, or any combination thereof.

14. The method of claim 10, wherein the authorization response and the authorization notification are indicative of an approval of the transaction, thereby completing the transaction.

15. The method of claim 10, wherein the authorization response and the authorization notification are indicative of a denial of the transaction, thereby voiding the transaction.

16. A method for conducting a transaction at a transaction card reader, the method comprising:
receiving a communication from an encoded portion of a transaction card at the transaction card reader, wherein the communication comprises a complete transaction card number stored on the encoded portion, and wherein the complete transaction card number includes a personalized indicia;
transmitting the complete transaction card number to an issuer of the transaction card for an initial authorization of the transaction;
receiving an initial authorization response from the issuer of the transaction card at the transaction card reader;
generating an initial authorization notification at the transaction card reader;
receiving a biometric input collected by a biometric sensor on the transaction card at the transaction card reader;
transmitting the biometric input to the issuer of the transaction card for a final authorization of the transaction;
receiving a final authorization response from the issuer of the transaction card at the transaction card reader; and
generating a final authorization notification at the transaction card reader.

17. The method of claim 16, wherein generating the initial and final authorization notifications each comprises displaying only the personalized indicia portion of the complete transaction number.

18. The method of claim 16, wherein the biometric input comprises a fingerprint scan, a facial recognition scan, or any combination thereof.

19. The method of claim 16, wherein the final authorization response and the final authorization notification are indicative of an approval of the transaction, thereby completing the transaction.

20. The method of claim 16, wherein the final authorization response and the final authorization notification are indicative of a denial of the transaction, thereby voiding the transaction.
